(19) United States
(12) Patent Application Publication
(10) Pub. No.: US 2017/0181166 A1
(43) Pub. Date: Jun. 22, 2017

(54) Run Time Radio Frequency Calibration for Receive Chains in Mobile Devices

(71) Applicant: QUALCOMM Incorporated, San Diego, CA (US)

(72) Inventors: Raghavendra Shyam Ananda, Hyderabad (IN); Niranjan Kumar Vadlamudi, Hyderabad (IN); Reza Shahidi, San Diego, CA (US); Anand Rajurkar, Hyderabad (IN); Tarandeep Virk, San Diego, CA (US)

(21) Appl. No.: 14/974,077

(22) Filed: Dec. 18, 2015

(51) Int. Cl. H04W 72/04; H04B 1/10; H04W 72/08

(52) U.S. Cl. CPC H04W 72/0453; H04W 72/085; H04B 1/1081; H04W 72/0446

(57) ABSTRACT

Various embodiments for calibrating receive chains on a mobile communication device may include identifying a calibrated receive chain and an un-calibrated receive chain of the mobile communication device and obtaining a first series of gain measurements for the calibrated receive chain and a second series of gain measurements for the un-calibrated receive chain. The mobile communication device may determine a path gain difference between the calibrated receive chain and the un-calibrated receive chain based on the first series of gain measurements and the second series of gain measurements, and compensate a gain of the un-calibrated receive chain using the path gain difference.

### BACKGROUND

Some designs of mobile communication devices—such as smart phones, tablet computers, and laptop computers—contain one or more Subscriber Identity Module (SIM) cards that provide users with access to multiple separate mobile telephony networks. Examples of mobile telephony networks include Third Generation (3G), Fourth Generation (4G), Long Term Evolution (LTE), Time Division Multiple Access (TDMA), Code Division Multiple Access (CDMA), CDMA 2000, Wideband CDMA (WCDMA), Global System for Mobile Communications (GSM), Single-Carrier Radio Transmission Technology (1×RTT), and Universal Mobile Telecommunications Systems (UMTS). A SIM may utilize a particular radio access technology (RAT) to communicate with its respective network.

Multi-SIM mobile communication devices have become increasingly popular because of their flexibility in service options and other features. For example, a wireless communication device that includes one or more SIMs and connects to two or more separate mobile telephony networks supporting two or more subscriptions using one or more shared radio frequency (RF) resources/radios may be termed a multi-MI, multi-standby (MSMS) communication device. When one subscription is using the RF resource, the other subscriptions are in stand-by mode and are not able to communicate using the RF resource. Another example of a multi-SIM device is a multi-SIM multi-active (MSMA) mobile communication device configured with multiple RF resources and multiple SIMs. Each SIM, or subscription, may utilize one or more RF resources for communication and thus multiple subscriptions may be actively communicating at the same time. For example, two subscriptions may utilize separate RF receive chains for receiving information from their respective networks.

The RF resource of a mobile communication device may include one or more transmitters, receivers, and/or transceivers to support one or more receive and transmit chains. Different RATs may utilize one or more of the receive and transmit chains during communication. For example, a LTE RAT with carrier aggregation may utilize multiple receive chains simultaneously.

Each receive chain in the RF resource of a mobile communication device is calibrated before leaving the factory. A receive chain is usually calibrated for each RAT supported by the mobile communication device, each frequency used by each RAT, and for each gain state of an amplifier in the receive chain. For example, if a mobile communication device includes three receive chains, supports two different RATs that each utilize four frequencies, and there are four gain states in each amplifier, then a total of ninety six calibration runs are completed in the factory. This means that the factory calibration process may take a long time, which reduces the output capability of the factory and increases the cost of manufacturing each device.

### SUMMARY

Various embodiments include methods implemented on a mobile communication device for calibrating receive chains on the mobile communication device. Various embodiments may include identifying a calibrated receive chain of the mobile communication device, identifying an un-calibrated receive chain of the mobile communication device, obtaining a first series of gain measurements for the calibrated receive chain, obtaining a second series of gain measurements for the un-calibrated receive chain, determining a path gain difference between the calibrated receive chain and the un-calibrated receive chain based on the first series of gain measurements and the second series of gain measurements, and compensating a gain of the un-calibrated receive chain based on the path gain difference.

Some embodiments may further include determining whether a radio frequency (RF) resource of the mobile communication device is free for use during a first time period, in which obtaining the first series of gain measurements for the calibrated receive chain includes tuning the RF resource to the calibrated receive chain and performing a plurality of measurement cycles during the first time period to obtain the first series of gain measurements, and obtaining the second series of gain measurements for the un-calibrated receive chain includes tuning the RF resource to the un-calibrated receive chain and performing the plurality of measurement cycles during the first time period to obtain the second series of gain measurements.

Some embodiments may further include adding a factory calibrated gain offset of the calibrated receive chain to an obtained gain measurement in the first series of gain measurements, and adding the factory calibrated gain offset to an obtained gain measurement in the second series of gain measurements. Some embodiments may further include determining, at the beginning of each measurement cycle, whether a gain state of an amplifier in the calibrated receive chain has changed, and ignoring previously obtained gain measurements for the calibrated receive chain and the un-calibrated receive chain in response to determining that the gain state of the amplifier in the calibrated receive chain has changed. Each measurement cycle in the plurality of measurement cycles may have a duration between 0.5 milliseconds and 2 milliseconds.

In some embodiments, determining the path gain difference between the calibrated receive chain and the un-calibrated receive chain may include determining a series of raw gain differences between corresponding gain measurements in the first series of gain measurements and the second series of gain measurements, and averaging the series of raw gain differences to obtain the path gain difference. In some embodiments, compensating the gain of the un-calibrated receive chain based on the path gain difference may include applying a factory calibrated gain offset of the calibrated receive chain and the path gain difference to the gain of the un-calibrated receive chain.

In some embodiments, the first series of gain measurements and the second series of gain measurements may be obtained using at least one of the same radio access technology, same frequency, and same state of an amplifier. Some embodiments may further include extrapolating the path gain difference for different frequencies used by the un-calibrated receive chain. In some embodiments, an input signal to the calibrated receive chain and the un-calibrated receive chain may be obtained from a pilot signal broadcast from a network base station. Some embodiments may further include associating the path gain difference with the un-calibrated receive chain and storing the path gain difference in memory.

Further embodiments include a mobile communication device including a memory and a processor configured with processor-executable instructions to perform operations of the methods described herein. Further embodiments include a non-transitory processor-readable storage medium having stored thereon processor-executable software instructions configured to cause a processor of a mobile communication device to perform operations of the methods described herein. Further embodiments include a mobile communication device that includes means for performing functions of the operations of the methods described herein.

### BRIEF DESCRIPTION OF THE DRAWINGS

The accompanying drawings, which are incorporated herein and constitute part of this specification, illustrate embodiments, and together with the general description and the detailed description given herein, serve to explain the features of the disclosed systems and methods.

FIG. 1 is a communication system block diagram of mobile telephony networks suitable for use with various embodiments.

FIG. 2 is a component block diagram of a multi-SIM mobile communication device according to various embodiments.

FIG. 3 is a component block diagram of an RF resource in a mobile communication device according to various embodiments.

FIG. 4 is a timing diagram illustrating a calibration gap for obtaining gain measurements for a calibrated and un-calibrated receive chain according to various embodiments.

FIG. 5 is another timing diagram illustrating measurement cycles for obtaining gain measurements for a calibrated and un-calibrated receive chain according to various embodiments.

FIG. 6 is a process flow diagram illustrating a method for calibrating receive chains on a mobile communication device according to various embodiments.

FIG. 7 is a process flow diagram illustrating a method for obtaining gain measurements for receive chains on a mobile communication device according to various embodiments.

FIG. 8 is a process flow diagram illustrating a method for determining a path gain difference between receive chains on a mobile communication device according to various embodiments.

FIG. 9 is a process flow diagram illustrating a method for compensating the gain of an un-calibrated receive chain on a mobile communication device according to various embodiments.

FIG. 10 is a component block diagram of a mobile communication device suitable for implementing some embodiment methods.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the written description or the claims.

As used herein, the term “mobile communication device,” “multi-SIM mobile communication device,” or “multi-SIM device” refers to any one or all of cellular telephones, smart phones, personal or mobile multi-media players, personal data assistants, laptop computers, tablet computers, smart books, smart watches, palm-top computers, wireless electronic mail receivers, multimedia Internet-enabled cellular telephones, wireless gaming controllers, and similar personal electronic devices that includes one or more SIM cards, a programmable processor, memory, and circuitry for connecting to at least two mobile communication network with one or more shared radio frequency (RF) resources. Various embodiments may be useful in mobile communication devices, such as smart phones, and so such devices are referred to in the descriptions of various embodiments. However, the embodiments may be useful in any electronic devices that may individually maintain a plurality of subscriptions that utilize at least one shared RF chain, which may include one or more of antennae, radios, transceivers, etc.

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a mobile communication device on a network and enable a communication service with the network. Because the information stored in a SIM enables the mobile communication device to establish a communication link for a particular communication service with a particular network, the term “subscription” is used herein as a shorthand reference to refer to the communication service associated with and enabled by the information stored in a particular SIM as the SIM and the communication network, as well as the services and subscriptions supported by that network, correlate to one another.

Mobile communication devices have one or more RF resources that SIMs/subscriptions may use to communicate with mobile telephony networks. The RF resources may include one or more receivers, transmitters, and/or transceivers that support one or more receive and transmit chains, or paths for receiving and transmitting information. For example, a mobile communication device with a LTE subscription capable of carrier aggregation may utilize multiple receive chains at the same time. In a multi-SIM communication device, the subscriptions may share the receive chains provided by the RF resource in the MSMS case, or may simultaneously use the receive chains in the MSMA case.

When mobile communication devices are assembled in the factory, each receive chain is calibrated. The calibration may occur for each RAT that the mobile communication device may utilize, each frequency utilized by each RAT, and for each gain state of an amplifier (e.g., a low noise amplifier). This may result in a large number of calibrations that occur before the mobile communication device leaves the factory, which may increase the cost of production and reduce the output of the factory.

In overview, various embodiments provide systems and methods implemented with a processor of a mobile communication device for calibrating one or more un-calibrated receive chains in the field (i.e., after leaving the factory). The calibration of the un-calibrated receive chains may be performed relative to an already calibrated receive chain. This may allow for fewer factory calibrations, which may reduce the cost of product and increase factory output.

The various embodiment methods may include identifying a calibrated receive chain and an un-calibrated receive chain of the mobile communication device and obtaining a first series of gain measurements for the calibrated receive chain and a second series of gain measurements for the un-calibrated receive chain. For example, the device processor may perform a number measurement cycles during a time period in which the RF resource is free for use. In each measurement cycle, the device processor may tune the RF resource to the calibrated receive chain, obtain a gain measurement in the first series of gain measurements, tune the RF resource to the un-calibrated receive chain, and obtain a corresponding gain measurement in the second series of gain measurements. The device processor may also check whether a gain state of an amplifier in the calibrated receive chain has changed at the beginning of each cycle and ignore previous gain measurements if the gain state of the amplifier has changed. The first series of gain measurements and the second series of gain measurements may be obtained using at least one of the same radio access technology, same frequency, and same gain state of an amplifier.

The device processor may then determine a path gain difference between the calibrated receive chain and the un-calibrated receive chain, for example by determining a series of raw gain differences between corresponding gain measurements in the first series of gain measurements and the second series of gain measurements and averaging the series of raw gain differences to obtain the path gain difference.

The device processor may compensate a gain of the un-calibrated receive chain using the path gain difference by applying a factory calibrated gain offset of the calibrated receive chain to the gain of the un-calibrated receive chain and then applying the path gain difference to the gain of the un-calibrated receive chain. The device processor may associate the path gain difference with the un-calibrated receive chain and store the path gain difference in memory.

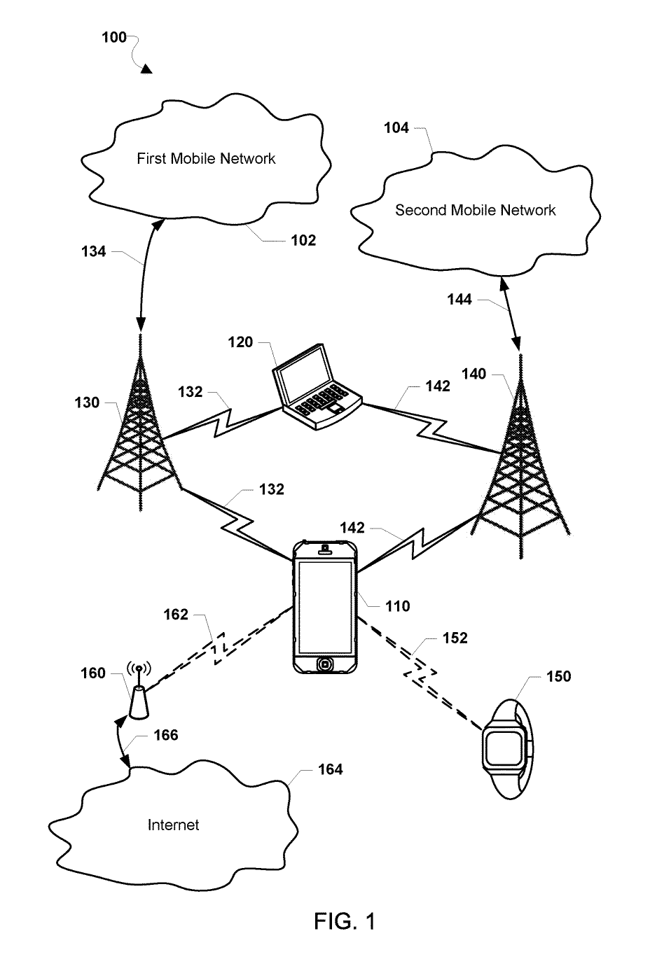

Various embodiments may be implemented within a variety of communication systems 100, such as at least two mobile telephony networks, an example of which is illustrated in FIG. 1. A first mobile network 102 and a second mobile network 104 typically each include a plurality of cellular base stations (e.g., a first base station 130 and a second base station 140). A first mobile communication device 110 may be in communication with the first mobile network 102 through a cellular connection 132 to the first base station 130. The first mobile communication device 110 may also be in communication with the second mobile network 104 through a cellular connection 142 to the second base station 140. The first base station 130 may be in communication with the first mobile network 102 over a wired connection 134. The second base station 140 may be in communication with the second mobile network 104 over a wired connection 144.

A second mobile communication device 120 may similarly communicate with the first mobile network 102 through the cellular connection 132 to the first base station 130. The second mobile communication device 120 may also communicate with the second mobile network 104 through the cellular connection 142 to the second base station 140. The cellular connections 132 and 142 may be made through two-way wireless communication links, such as Third Generation (3G), Fourth Generation (4G), Long Term Evolution (LTE), Time Division Multiple Access (TDMA), Code Division Multiple Access (CDMA), Wideband CDMA (WCDMA), Global System for Mobile Communications (GSM), Universal Mobile Telecommunications Systems (UMTS), and other mobile telephony communication technologies.

While the mobile communication devices 110, 120 are shown connected to the first mobile network 102 and, optionally, to the second mobile network 104, in some embodiments (not shown), the mobile communication devices 110, 120 may include two or more subscriptions to two or more mobile networks and may connect to those subscriptions in a manner similar to those described herein.

In some embodiments, the first mobile communication device 110 may optionally establish a wireless connection 152 with a peripheral device 150 used in connection with the first mobile communication device 110. For example, the first mobile communication device 110 may communicate over a Bluetooth® link with a Bluetooth-enabled personal computing device (e.g., a “smart watch”). In some embodiments, the first mobile communication device 110 may optionally establish a wireless connection 162 with a wireless access point 160, such as over a Wi-Fi connection. The wireless access point 160 may be configured to connect to the Internet 164 or another network over a wired connection 166.

While not illustrated, the second mobile communication device 120 may similarly be configured to connect with the peripheral device 150 and/or the wireless access point 160 over wireless links.

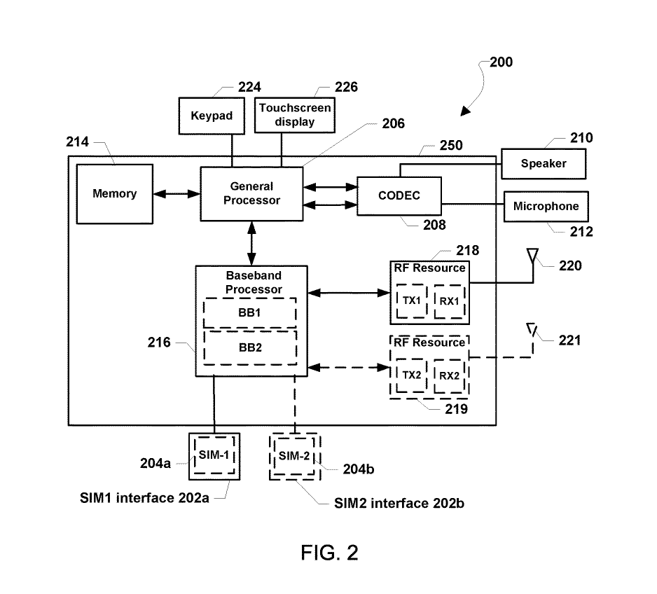

FIG. 2 is a functional block diagram of a multi-SIM mobile communication device 200 suitable for implementing various embodiments. With reference to FIGS. 1-2, the multi-SIM mobile communication device 200 may be similar to one or more of the mobile communication devices 110, 120 as described. The multi-SIM mobile communication device 200 may include a first SIM interface 202a, which may receive a first identity module SIM-1 204a that is associated with a first subscription. The multi-SIM mobile communication device 200 may also optionally include a second SIM interface 202b, which may receive an optional second identity module SIM-2 204b that is associated with a second subscription.

A SIM in various embodiments may be a Universal Integrated Circuit Card (UICC) that is configured with SIM and/or Universal SIM applications, enabling access to, for example, GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. A SIM card may have a central processing unit (CPU), read only memory (ROM), random access memory (RAM), electrically erasable programmable read only memory (EEPROM) and input/out (I/O) circuits.

A SIM used in various embodiments may contain user account information, an international mobile subscriber identity (IMSI), a set of SIM application toolkit (SAT) commands, and storage space for phone book contacts. A SIM card may further store home identifiers (e.g., a System Identification Number (SID)/Network Identification Number (NID) pair, a Home Public Land Mobile Number (HPLMN) code, etc.) to indicate the SIM card network operator provider. An Integrated Circuit Card Identity (ICCID) SIM serial number may be printed on the SIM card for identification. However, a SIM may be implemented within a portion of memory of the multi-SIM mobile communication device 200 (e.g., in a memory 214), and thus need not be a separate or removable circuit, chip or card.

The multi-SIM mobile communication device 200 may include at least one controller, such as a general processor 206, which may be coupled to a coder/decoder (CODEC) 208. The CODEC 208 may in turn be coupled to a speaker 210 and a microphone 212. The general processor 206 may also be coupled to the memory 214. The memory 214 may be a non-transitory computer-readable storage medium that stores processor-executable instructions. For example, the instructions may include routing communication data relating to the first or second subscription though a corresponding baseband-RF resource chain.

The memory 214 may store an operating system (OS), as well as user application software and executable instructions. The memory 214 may also store application data and may store exclude lists for RATs on the multi-SIM mobile communication device 200.

The general processor 206 and the memory 214 may each be coupled to at least one baseband modem processor 216. Each SIM and/or RAT in the multi-SIM mobile communication device 200 (e.g., the SIM-1 204a and/or the SIM-2 204b) may be associated with a baseband-RF resource chain. A baseband-RF resource chain may include the baseband modem processor 216, which may perform baseband/modem functions for communications with/controlling a RAT, and may include one or more amplifiers and radios, referred to generally herein as RF resources (e.g., RF resource 218, 219). In some embodiments, baseband-RF resource chains may share the baseband modem processor 216 (i.e., a single device that performs baseband/modem functions for all RATs on the multi-SIM mobile communication device 200). In other embodiments, each baseband-RF resource chain may include physically or logically separate baseband processors (e.g., BB1, BB2).

The RF resource 218 may be a transceiver that performs transmit/receive functions for each of the SIMs/RATs on the multi-SIM mobile communication device 200. The RF resource 218 may include separate transmit and receive circuitry, or may include a transceiver that combines transmitter and receiver functions. In some embodiments, the RF resource 218 may include multiple receive circuitries. The RF resource 218 may be coupled to a wireless antenna (e.g., a wireless antenna 220). The RF resource 218 may also be coupled to the baseband modem processor 216. In some optional embodiments, the multi-SIM mobile communication device 200 may include an optional RF resource 219 configured similarly to the RF resource 218 and coupled to an optional wireless antenna 221.

In some embodiments, the general processor 206, the memory 214, the baseband processor(s) 216, and the RF resources 218, 219 may be included in the multi-SIM mobile communication device 200 as a system-on-chip 250. In some embodiments, the first and second SIMs 204a, 204b and the corresponding interfaces 202a, 202b to each subscription may be external to the system-on-chip 250. Further, various input and output devices may be coupled to components on the system-on-chip 250, such as interfaces or controllers. Example user input components suitable for use in the multi-SIM mobile communication device 200 may include, but are not limited to, a keypad 224, a touchscreen display 226, and the microphone 212.

In some embodiments, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive selection of a contact from a contact list or receive a telephone number. As another example, the request to initiate the outgoing call may be in the form of a voice command received via the microphone 212. Interfaces may be provided between the various software modules and functions in the multi-SIM mobile communication device 200 to enable communication between them, as is known in the art.

Functioning together, the two SIMs 204a, 204b, the baseband processor BB1, BB2, the RF resources 218, 219, and the wireless antennas 220, 221 may constitute two or more radio access technologies (RATs). For example, the multi-SIM mobile communication device 200 may be a LTE communication device that includes a SIM, baseband processor, and RF resource configured to support two different RATs, such as LTE, WCDMA, and GSM. More RATs may be supported on the multi-SIM mobile communication device 200 by adding more SIM cards, SIM interfaces, RF resources, and antennae for connecting to additional mobile networks.

In some embodiments (not shown), the multi-SIM mobile communication device 200 may include, among other things, additional SIM cards, SIM interfaces, a plurality of RF resources associated with the additional SIM cards, and additional antennae for supporting subscriptions communications with additional mobile networks.

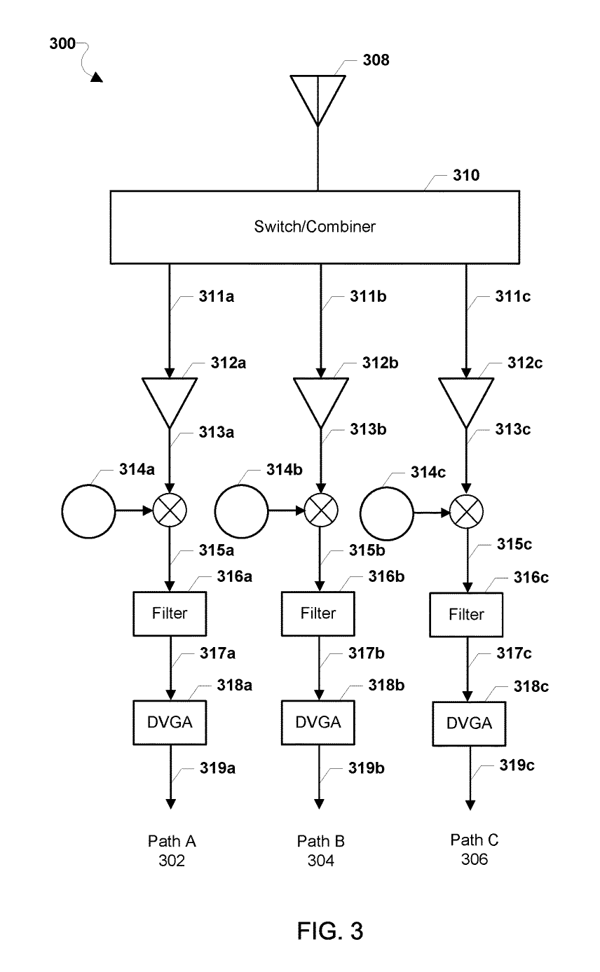

FIG. 3 illustrates a component block diagram of a RF resource 300 in a mobile communication device according to various embodiments. In some embodiments, the RF resource 300 may correspond to the RF resource 218, 219. With reference to FIGS. 1-3, the RF resource 300 supports three receive chains: a first receive chain 302 (“Path A”), a second receive chain 304 (“Path B”), and a third receive chain 306 (“Path C”). In general, RF resources in mobile communication devices may support any number of receive chains and is not limited to three receive chains as illustrated in the RF resource 300.

The RF resource 300 may include one or more antennas 308 for receiving wireless communication signals from mobile telephony networks such as LTE, GSM, or CDMA. The antennas 308 may be connected to a switch/combiner 310 which passes signals received by the antennas 308 to one or more of the receive chains 302, 304, and 306. For instance, the switch/combiner 310 may pass a first signal 311a to the first receive chain 302, a second signal 311b to the second receive chain 304, and a third signal 311c to the third receive chain 306.

Each receive chain 302, 304, and 306 may include a low noise amplifier (LNA) 312a-312c for amplifying the signals 311a-311c to provide amplified signals 313a-313c. After the amplified signals 313a-313c are provided by the LNAs 312a-312c, a phase locked loop (PLL) module 314a-314c may be applied to the amplified signals 313a-313c. The PLL modules 314a-314c may be used to demodulate the amplified signals 313a-313c into demodulated signals 315a-315c. Filters 316a-316c (e.g., baseband filters) may be used to isolate a narrow frequency range for the demodulated signals 315a-315c. Filtered signals 317a-317c may then be passed through digital variable gain amplifiers (DVGAs) 318a-318c to amplify the filtered signals 317a-317c before passing resulting amplified signals 319a-319c to the SIM/subscription for decoding. Each receive chain 302, 304, and 306 may have fewer components or additional components not illustrated in the RF resource 300, and furthermore may have different components from each other. FIG. 3 merely illustrates a non-limiting example of the RF resource 300.

With reference to FIGS. 1-3, each receive chain 302, 304, and 306 may be calibrated in the factory. Calibration of a receive chain may include applying a constant input power to the receive chain (e.g., from a transmitter of the mobile communication device or an external power supply) and measuring the output power of the receive chain. The gain of the receive chain may be derived from the input power received by the antennas 308 and the output power (e.g., output of the amplifiers 318a-318c). For example, the gain may be a function of the logarithm of the ratio of output power to input power. A receive chain may have an ideal gain, but variations or imperfections in the components and materials used to construct the receive chain may result in a gain that deviates from the ideal gain. For example, a receive chain may have an ideal or designed gain of 10 decibels (dB) but an actual gain of 9.8 dB.

Software in the mobile communication device may then be configured to apply a factory calibrated gain offset to the receive chain in order to achieve the ideal gain. For example, a gain offset of +0.2 dB may be applied to the receive chain with actual gain of 9.8 dB to achieve the ideal gain of 10 dB.

Typically, each receive chain in a mobile communication device is calibrated for each RAT that may be utilized by the mobile communication device (e.g., LTE, GSM, and CDMA), the center frequency of each frequency bands utilized by each RAT, and each gain state of an amplifier in the receive chain (e.g., each LNA 312a-312c may apply different amounts of gain to the signal in each gain state). Thus each unique combination of RAT, frequency, and amplifier gain state may result in a different gain offset being applied to the receive chain to achieve the ideal gain for that combination. For example, if a mobile communication device with the RF resource 300 communicates using three different RATs, with each RAT utilizing three different frequencies, and each receive chain has four amplifier gain states, a total of 108 calibrations may be performed to fully calibrate the receive chains 302, 304, and 306.

However, various embodiments described herein allow a mobile communication device to calibrate receive chains in the field (i.e., after manufacturing of the mobile communication device), and thus may reduce the number of calibrations that occur in the factory. For instance, the first receive chain 302 may be fully calibrated in the factory for every combination of RATs, frequencies, and amplifier gain states. The third receive chain 306 may be partially calibrated in the factory, or not calibrated at all. However, a gain offset may be determined for the third receive chain 306 relative to the factory calibrated gain offset of the first receive chain 302 given the same RAT, frequency, and amplifier gain state. For example, a LTE subscription with carrier aggregation may attempt to utilize both the calibrated and un-calibrated receive chain (e.g., the first receive chain 302 and the third receive chain 306, respectively) for simultaneous reception. Because both the RAT and frequency are the same for both receive chains, the calibrated receive chain may be used to calibrate the un-calibrated receive chain in the field, given the same amplifier gain state.

In order to calibrate an un-calibrated receive chain relative to a calibrated receive chain, the gain of both receive chains may be compared if the same input power is applied to both receive chains. In the field this may be difficult to accomplish because received signals usually vary in power over time. However, over small periods in time (e.g., within 0.5 to 2 milliseconds (ms)), the received input power of a signal may be constant enough to make a comparison between the gains of the un-calibrated receive chain and the calibrated receive chain.

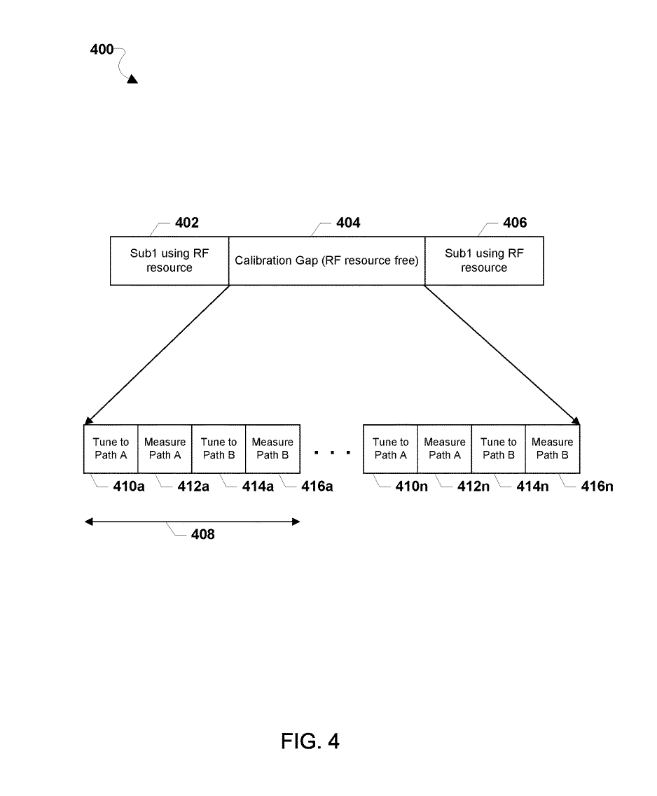

FIG. 4 illustrates a timing diagram 400 for making gain measurements of an un-calibrated receive chain and a calibrated receive chain in the field according to various embodiments. With reference to FIGS. 1-4, the timing diagram 400 illustrates the availability of an RF resource (e.g., the RF resource 300) in a mobile communication device (e.g., 110, 200) over time. During time period 402, the RF resource may be used by a first subscription on the mobile communication device. For example, the first subscription (e.g., LTE, GSM, or CDMA) may be transmitting or receiving data from an associated network during the time period 402. Likewise, during time period 406 the RF resource may also be in use by the first subscription (or another subscription on the mobile communication device).

However, during time period 404, the RF resource may not be used by the first subscription or any other subscription on the mobile communication device. Thus the RF resource may be free to use during the time period 404 to perform gain measurements in order to calibrate an un-calibrated receive chain. The time period 404 may be termed a “calibration gap,” and may have a duration between 5 ms to 20 ms.

During the time period 404, the RF resource may be successively tuned between a calibrated receive chain (e.g., “Path A”) and an un-calibrated receive chain (e.g., “Path B”) over a number of measurement cycles 408. There may be n number of measurement cycles 408 in the time period 404. For example, if the time period 404 lasts for 10 ms and each measurement cycle 408 lasts for 1 ms, then a total of ten measurement cycles 408 may be performed within the time period 404. During the time period 404, the gain measurements for Path A and Path B may be obtained using the same RAT, frequency, and amplifier gain state so that the gains may be directly compared.

In each measurement cycle 408, the RF resource may be tuned to Path A in operations 410a-410n. The output power and gain of Path A may be measured in operations 412a-412n to obtain a series of gain measurements for Path A. The RF resource may then be tuned to Path B in operations 414a-414n. The output power and gain of Path B may be measured in operations 416a-416n to obtain a series of gain measurements for Path B. The time period for each measurement cycle 408 may be between 0.5 ms to 2 ms, which may be short enough to ensure a constant input power over each measurement cycle 408. Thus the gain of Path A and Path B may be directly compared because both paths received the same input power through the antenna of the RF resource. In other embodiments, the tuning and measurement of the un-calibrated receive chain (e.g., Path B) may be performed before the tuning and measurement of the calibrated receive chain (e.g., Path A).

In some embodiments, the input signal used to obtain the gain measurements may be an input reception signal sent from a network. In some embodiments, a pilot channel may be utilized to perform the gain measurements. For example, certain networks (e.g., CDMA) may provide a pilot channel that broadcasts a constant power pilot signal. The RF resource may be tuned to the pilot signal in order to obtain the gain measurements for both Path A and Path B.

Once the gain measurements for the calibrated and un-calibrated receive chains are obtained in the time period 404, the path gain difference between the two receive chains may be calculated.

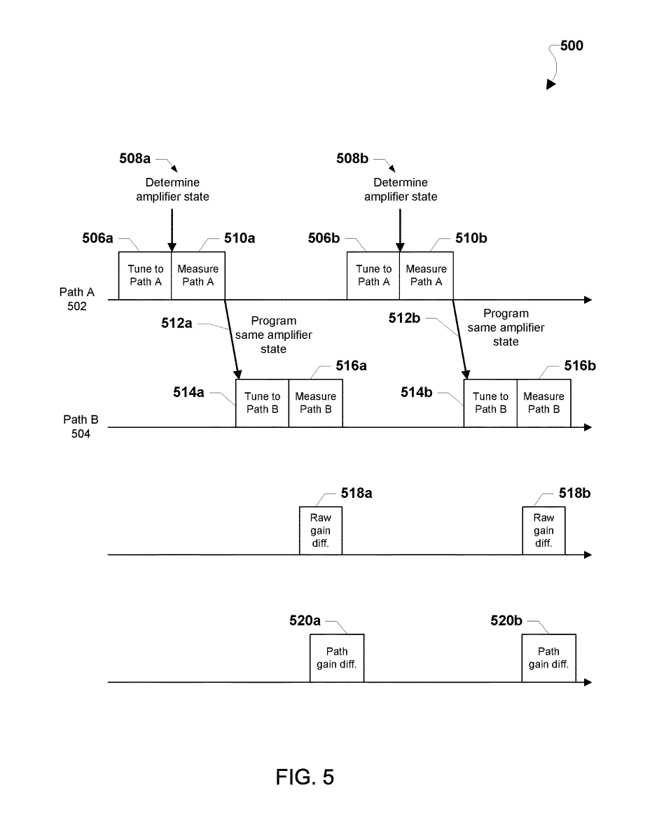

FIG. 5 illustrates a timing diagram 500 for determining the path gain difference between a calibrated receive chain and an un-calibrated receive chain of a mobile communication device according to various embodiments. With reference to FIGS. 1-5, the timing diagram 500 shows gain measurement operations conducted for a calibrated receive chain 502 (“Path A”) and an un-calibrated receive chain 504 (“Path B”). The gain measurements may be conducted using the same RAT, frequency, and amplifier gain state for both the calibrated receive chain 502 and the un-calibrated receive chain 504.

During a measurement cycle (e.g., the measurement cycles 408) in a calibration gap (e.g., the time period 404) on a RF resource (e.g., 300), the RF resource may be tuned to the calibrated receive chain 502 in operation 506a. A gain state of an amplifier (e.g., LNA 312a) in the calibrated receive chain 502 may be determined in operation 508a. An output power and gain of the calibrated receive chain 502 may be measured in operation 510a. In some embodiments, a factory calibrated gain offset may also be applied to the gain of the calibrated receive chain 502.

The RF resource may then be tuned to the un-calibrated receive chain 504 in operation 514a. The amplifier gain state of the calibrated receive chain 502 may be programmed into the amplifier (e.g., LNA 312b) of the un-calibrated receive chain 504 in operation 512a, ensuring that the same amplifier gain state is used for both receive chains 502, 504. A corresponding output power and gain of the un-calibrated receive chain 504 may be measured in operation 516a. The factory calibrated data of the calibrated receive chain 502 may also be applied to the un-calibrated receive chain 504. For example, the factory calibrated gain offset applied to the calibrated receive chain 502 may also be applied to the gain of the un-calibrated receive chain 504.

A first raw gain difference 518a between the calibrated receive chain 502 and the un-calibrated receive chain 504 may be calculated from the gain measurements obtained in operations 510a and 516a. For example, the first raw gain difference 518a may be calculated as the measured gain of the calibrated receive chain 502 minus the measured gain of the un-calibrated receive chain 504.

A path gain difference 520a may be calculated based on previously determined raw gain differences. For instance, the path gain difference 520a may be calculated by averaging all previously determined raw gain differences. Averaging the raw gain differences may be done to reduce or remove noise that is present in individual raw gain difference calculations. During the first measurement cycle, the path gain difference 520a may be equal to the raw gain difference 518a. In other embodiments, the path gain difference 520a may be calculated in any suitable manner (e.g., mean of measurements, weighted measurements, etc.), for instance, to reduce or remove noise or other variations in individual raw gain difference calculations.

When the next measurement cycle starts, the RF resource may be tuned back to the calibrated receive chain 502 in operation 506b. The amplifier gain state of the calibrated receive chain 502 may be determined in operation 508b. If the determined amplifier gain state has changed from previous measurement cycles (e.g., if the amplifier gain state determined in operation 508b is different from the amplifier gain state determined in operation 508a), the previous gain difference calculations (e.g., the raw gain difference 518a) may be discarded or ignored when determining the path gain difference because the amplifier gain states should be the same throughout the calibration process.

The output power and gain of the calibrated receive chain 502 may be measured in operation 510b. The factory calibrated gain offset may also be applied to the gain of the calibrated receive chain 502. The RF resource may be tuned to the un-calibrated receive chain 504 in operation 514b. The amplifier gain state of the calibrated receive chain 502 may be programmed into the amplifier of the un-calibrated receive chain 504 in operation 512b, ensuring that the same amplifier gain state is used for both receive chains 502, 504. The corresponding output power and gain of the un-calibrated receive chain 504 may be measured in operation 516b. The factory calibrated gain offset applied to the calibrated receive chain 502 may also be applied to the gain of the un-calibrated receive chain 504.

A second raw gain difference 518b between the calibrated receive chain 502 and the un-calibrated receive chain 504 may be calculated from the gain measurements obtained in operations 510b and 516b. A second path gain difference 520b may be calculated based on previously determined raw gain differences. For instance, the path gain difference 520b may be calculated by averaging the raw gain differences 518a and 518b assuming the amplifier gain state is the same across all the gain measurements. In other embodiments, the path gain difference 520b may be calculated in any suitable manner (e.g., mean of measurements, weighted measurements, etc.), for instance, to reduce or remove noise or other variations in individual raw gain difference calculations.

The measurement cycles may be repeated a number of times within the calibration gap. Once the calibration gap is complete, the path gain difference determined from the average of all the raw gain differences (e.g., the first raw gain difference 518a, the second raw gain difference 518b, and any other raw gain difference calculations from other measurement cycles within the calibration gap) calculated for each measurement cycle may be used to calibrate the un-calibrated receive chain 504 relative to the calibrated receive chain 502. In some embodiments, a factory calibrated gain offset of the calibrated receive chain 502 may also be used to calibrate the un-calibrated receive chain 504 (e.g., as described in method 900 in FIG. 9).

For example, the calibrated receive chain 502 may have a factory calibrated gain offset of 0.2 dB (e.g., an actual gain of 9.8 dB and an ideal gain of 10 dB). The calculated path gain difference between the calibrated receive chain 502 and the un-calibrated receive chain 504 may be −0.3 dB (e.g., the un-calibrated receive chain 504 may have an actual gain of 10.1 dB, and an ideal gain of 10 dB). The factory calibrated gain offset of the calibrated receive chain 502 and the path gain difference may both be applied to the actual gain of the un-calibrated receive chain 504 to obtain the ideal gain (e.g., 10.1 dB+0.2 dB−0.3 dB=10 dB).

The path gain difference (e.g., 520b) may be associated with the un-calibrated receive chain 504 and stored in memory (e.g., 214) on the mobile communication device, along with the RAT, frequency, amplifier gain state used in the calibration, and/or the like. When the un-calibrated receive chain 504 is used in the future by the same combination of RAT, frequency, and amplifier gain state, the calculated path gain difference may be used to adjust the gain. Interpolation or extrapolation may also be used to obtain path gain differences for the same receive chain, RAT and amplifier gain state but different frequency. In certain circumstances, there may be a preference to use the calibrated receive chain 502 rather than the un-calibrated receive chain 504. For example, the calibrated receive chain 502 and the un-calibrated receive chain 504 may be used simultaneously in dual receive mode. In weak radio conditions, there may be a fall back to single receive mode on the calibrated receive chain 502 in order to avoid errors that may occur in the field calibration of the un-calibrated receive chain 504.

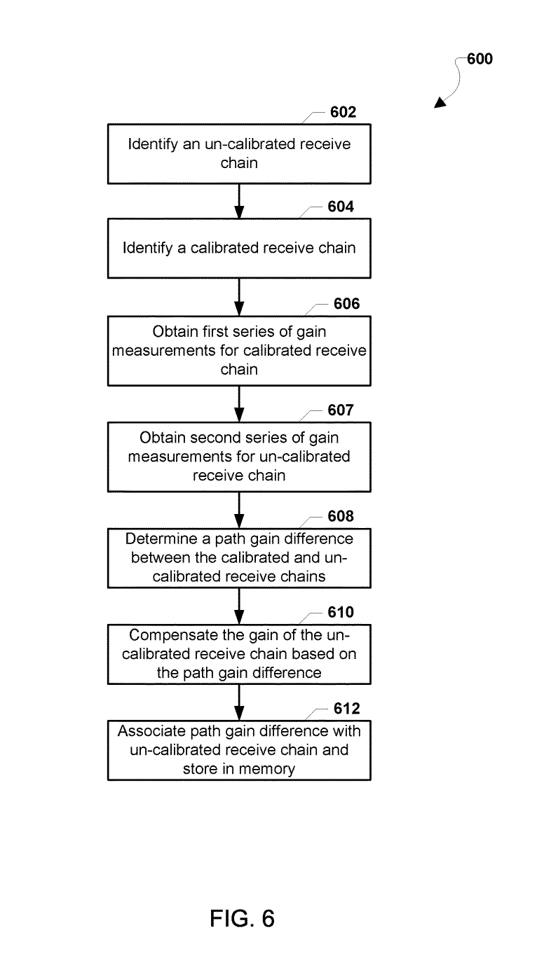

FIG. 6 illustrates a method 600 for calibrating receive chains on a mobile communication device according to various embodiments. With reference to FIGS. 1-6, the method 600 may be implemented with a processor (e.g., the general processor 206, the baseband modem processor 216, a separate controller, and/or the like) of a mobile communication device (such as the mobile communication devices 110, 120, 200) that supports one or more SIMs/subscriptions.

In block 602, the processor may identify an un-calibrated receive chain in the mobile communication device. For example, the processor may attempt to utilize a receive chain for a specific RAT, frequency, and amplifier gain state. The processor may determine that no or otherwise incomplete calibration data is stored for the receive chain in memory and is thus un-calibrated.

In block 604, the processor may identify a calibrated receive chain. The calibrated receive chain may have factory calibration data stored in memory for a specific RAT, frequency, and amplifier gain state (e.g., the same parameters as the processor is attempting to use with the un-calibrated receive chain). For example, the calibrated receive chain may be a primary receive chain used by a subscription with carrier aggregation, and the un-calibrated receive chain may be a secondary receive chain for the subscription.

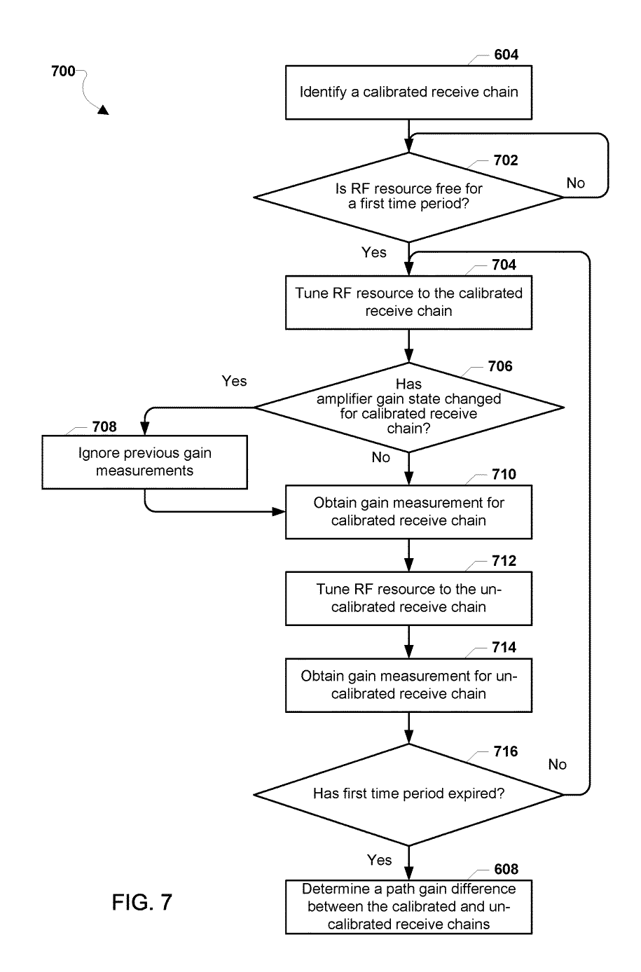

In block 606, the processor may obtain a first series of gain measurements for the calibrated receive chain. In block 607 the processor may obtain a second series of gain measurements for the un-calibrated receive chain. The input power for each pair of corresponding gain measurements in the first and second series of gain measurements may be the same. The source of the input signal may be an incoming reception signal, or a pilot signal broadcast by certain networks. The processor may identify a first time period during which the RF resource is free (i.e., a calibration gap). The processor may then perform successive gain measurements for the calibrated receive chain and the un-calibrated receive chain over multiple measurement cycles within the first time period. The RAT, frequency, and amplifier gain state used to obtain the first and second series of gain measurements may be the same. Obtaining the first and second series of gain measurements is described in more detail, for example, with reference to method 700 (FIG. 7).

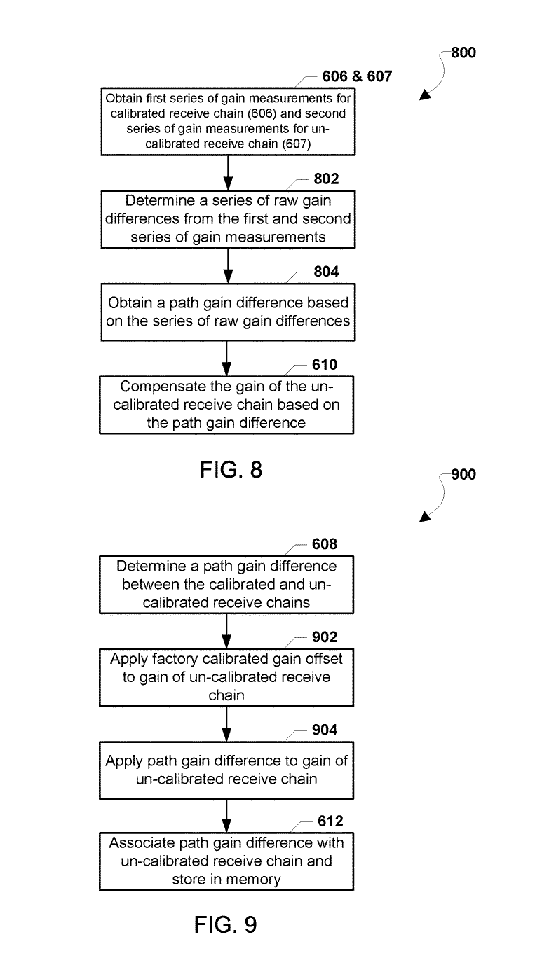

In block 608, the processor may determine a path gain difference between the calibrated and un-calibrated receive chains based on the first and second series of gain measurements. For example, the path gain difference may be the average of the raw gain difference for each pair of corresponding gain measurements in the first and second series of gain measurements. Determining path gain difference is described in more detail, for example, with reference to method 800 (FIG. 8).

In block 610, the processor may compensate the gain of the un-calibrated receive chain based on the path gain difference. For example, the compensation may be done using the determined path gain difference and the factory calibrated gain offset of the calibrated receive chain. Compensating the gain of the un-calibrated receive chain is described in more detail, for example, with reference to method 900 (FIG. 9).

In block 612, the processor may associate the path gain difference with the un-calibrated receive chain and store the path gain difference in memory on the mobile communication device for future use. The processor may also store information regarding the RAT, frequency, amplifier gain state, and/or the like used to obtain the path gain difference. In this manner, the method 600 allows for calibration of an un-calibrated receive chain in the field using a calibrated receive chain.

FIG. 7 illustrates the method 700, which is for obtaining gain measurements for receive chains on a mobile communication device according to various embodiments. With reference to FIGS. 1-7, the method 700 includes operations that may be performed in blocks 606 and 607 of the method 600, and may be implemented with a processor (e.g., the general processor 206, the baseband modem processor 216, a separate controller, and/or the like) of a mobile communication device (such as the mobile communication devices 110, 120, 200) that supports one or more SIMs/subscriptions.

After identifying a calibrated receive chain in block 604, the processor may determine whether the RF resource (e.g., the RF resource 300) of the mobile communication device is free for the first time period in determination block 702. For example, the processor may determine whether any subscription on the mobile communication device is currently using the RF resource or is scheduled to use the RF resource before the expiration of the first time period. The first time period may have a duration between 5 ms and 20 ms. In other embodiments, a different duration length (i.e., less than 5 ms or greater than 20 ms) may be implemented.

In response to determining that the RF resource is not free for the first time period (i.e., determination block 702=“No”), the processor may continue to wait until the RF resource is free for the first time period in determination block 702. In response to determining that the RF resource is free for the first time period (i.e., determination block 702=“Yes”), the processor may tune the RF resource to the calibrated receive chain (if not already tuned to this receive chain) in block 704. In other words, in response to determining that the RF resource is free for the first time period (e.g., a calibration gap) the processor may initiate a plurality of measurement cycles (each cycle including blocks 704 to 714) within the first time period to obtain a series of gain measurements for the calibrated and un-calibrated receive chains. For example, the first series of gain measurements for the calibrated receive chain may be obtained by repeating the gain measurements in block 710 over the plurality of measurement cycles. Likewise, the second series of gain measurements for the un-calibrated receive chain may be obtained by repeating the gain measurements in block 714 over the plurality of measurement cycles.

The duration of each measurement cycle may be between 0.5 ms and 2 ms. This may allow the processor to obtain corresponding gain measurements from the calibrated and un-calibrated receive chain with a constant input power within each measurement cycle. The input signal may be, for example, a reception signal or a pilot signal sent from a network. In other embodiments, a different duration length (i.e., less than 0.5 ms or greater than 2 ms) may be implemented.

In determination block 706, the processor may determine whether the gain state of an amplifier in the calibrated receive chain has changed. The calibrated receive chain may have an amplifier (e.g., a LNA) that has multiple gain states. The processor may store the gain state of the amplifier and determine whether it is different from the stored gain state of the amplifier from the previous measurement cycle (except during the first measurement cycle).

In response to determining that the amplifier gain state has changed for the calibrated receive chain (i.e., determination block 706=“Yes”), the processor may ignore previously collected gain measurements of the calibrated and un-calibrated receive chain in block 708. In order to calibrate the un-calibrated receive chain using the calibrated receive chain by comparing the difference in gain measurements, the amplifier gain state should be the same across the series of gain measurements obtained from the calibrated and un-calibrated receive chains. If the amplifier gain state of the calibrated receive chain has changed, then previous gain measurements may be ignored or discarded.

In response to determining that the amplifier gain state of the calibrated receive chain has not changed (i.e., determination block 706=“No”), or after ignoring the previous gain measurements in block 708, the processor may obtain a gain measurement for the calibrated receive chain in block 710 (which may correspond to block 606). For example, the processor may determine the gain as a function of the ratio of the measured output power to the input power for the calibrated receive chain. The processor may apply a factory calibrated gain offset to the gain measurement of the calibrated receive chain.

In block 712, the processor may tune the RF resource to the un-calibrated receive chain. In block 714 (which may correspond to block 607), the processor may obtain a corresponding gain measurement for the un-calibrated receive chain. For example, the processor may determine the gain as a function of the ratio of the measured output power to the input power for the un-calibrated receive chain. Before obtaining the gain measurement, the processor may set an amplifier (e.g., a LNA) in the un-calibrated receive chain to the same gain state as the amplifier in the calibrated receive chain. The processor may also apply the factory calibrated gain offset of the calibrated receive chain to the gain measurement of the un-calibrated receive chain.

In determination block 716, the processor may determine whether the first time period has expired. In response to determining that the first time period has not expired (i.e., determination block 716=“No”), the processor may initiate another measurement cycle by tuning the RF resource to the calibrated receive chain in block 704. In response to determining that the first time period has expired (i.e., determination block 716=“Yes”), the processor may then determine a path gain difference between the calibrated and un-calibrated receive chains based on the first and second series of gain measurements in block 608 of the method 600 as described. In this manner, the method 700 allows a mobile communication device to obtain gain measurements of a calibrated and un-calibrated receive chain to use in a field calibration.

FIG. 8 illustrates the method 800, which is for determining a path gain difference between receive chains on a mobile communication device according to various embodiments. With reference to FIGS. 1-8, the method 800 includes operations that may be performed in block 608 of the method 600, and may be implemented with a processor (e.g., the general processor 206, the baseband modem processor 216, a separate controller, and/or the like) of a mobile communication device (such as the mobile communication devices 110, 120, 200) that supports one or more SIMs/subscriptions.

After obtaining a first series of gain measurements for the calibrated receive chain and a second series of gain measurements for the un-calibrated receive chain in blocks 606 and 607, the processor may determine a series of raw gain differences from the first and second series of gain measurements in block 802. For example, each raw gain difference may be calculated by subtracting a gain measurement from the second series of gain measurements of the un-calibrated receive chain from a corresponding gain measurement from the first set of gain measurements of the calibrated receive chain (i.e., P_{calibrated}−P_{un-calibrated}). Corresponding gain measurements may be gain measurements of the calibrated and un-calibrated receive chains obtained within the same measurement cycle. If the gain state of an amplifier in the calibrated receive chain changed between measurement cycles (e.g., block 708), gain measurements obtained before the amplifier gain state change may be ignored and not used to calculate the series of raw gain differences.

In block 804, the processor may obtain the path gain difference based on the series of raw gain differences. For example, the path gain difference may be calculated by averaging the series of raw gain differences. This averaging may be used to remove or reduce noise from the gain difference of each individual measurement cycle. In other embodiments, the path gain difference may be calculated in any suitable manner (e.g., mean of measurements, weighted measurements, etc.), for instance, to reduce or remove noise or other variations in individual raw gain difference calculations.

The processor may then compensate the gain of the un-calibrated receive chain based on the path gain difference in block 610 of the method 600 as described. The method 600 may then continue. For instance, the processor may then associate the path gain difference with the un-calibrated receive chain and store the path gain difference in memory on the mobile communication device for future use in block 612 of the method 600 as described. In this manner, the method 800 allows a mobile communication device to determine a path gain difference between a calibrated and un-calibrated receive chain in the field.

FIG. 9 illustrates the method 900, which is for compensating the gain of an un-calibrated receive chain using the path gain difference with a calibrated receive chain on a mobile communication device according to various embodiments. With reference to FIGS. 1-9, the method 900 includes operations that may be performed in block 610 of the method 600, and may be implemented with a processor (e.g., the general processor 206, the baseband modem processor 216, a separate controller, and/or the like) of a mobile communication device (such as the mobile communication devices 110, 120, 200) that supports one or more SIMs/subscriptions.

After determining a path gain difference between the calibrated and un-calibrated receive chains based on the first and second series of gain measurements in block 608 (or block 804), the processor may apply a factory calibrated gain offset of the calibrated receive chain to the gain of the un-calibrated receive chain in block 902. The factory calibrated gain offset may be stored in memory and determined when the calibrated receive chain was calibrated in the factory.

In block 904, the processor may apply the path gain difference to the gain of the un-calibrated receive chain. By applying both the factory calibrated gain offset and the path gain difference, the gain of the un-calibrated receive chain may be adjusted to be approximately equal to the ideal gain for the un-calibrated receive chain. For example, the calibrated receive chain may have an ideal gain of 10 dB, an actual gain of 10.3 dB, and a factory calibrated gain offset of −0.3 dB. The path gain difference between the calibrated and un-calibrated receive chains may be determined to be 0.5 dB, which means the actual gain of the un-calibrated receive chain is 9.8 dB (9.8 dB+0.5 dB=10.3 dB). The ideal gain of the un-calibrated receive chain may be 10 dB. The actual gain of the un-calibrated receive chain may then be adjusted by the factory calibrated gain offset and the path gain difference to equal the ideal gain (i.e., 9.8 dB−0.3 dB+0.5 dB=10 dB). As such blocks 902 and/or 904 may correspond to block 610.

The processor may then associate the path gain difference with the un-calibrated receive chain and store at least the path gain difference in memory on the mobile communication device for future use in block 612 of the method 600 as described. In this manner, the method 900 allows a mobile communication device to compensate the gain of an un-calibrated receive chain relative to a calibrated receive chain in the field.

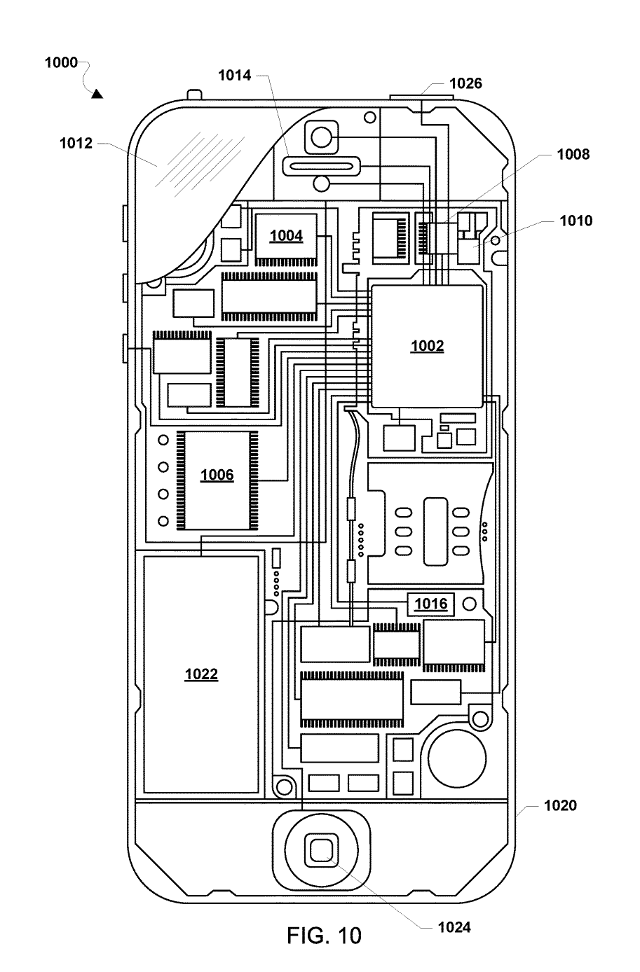

Various embodiments may be implemented in any of a variety of communication devices, an example of which (e.g., multi-SIM mobile communication device 1000) is illustrated in FIG. 10. With reference to FIGS. 1-2, the multi-SIM mobile communication device 1000 may be similar to the mobile communication devices 110, 120, 200, as described. As such, the multi-SIM mobile communication device 1000 may implement the methods 600, 700, 800, and 900 according to various embodiments.

The multi-SIM mobile communication device 1000 may include a processor 1002 coupled to a touchscreen controller 1004 and an internal memory 1006. The processor 1002 may be one or more multi-core integrated circuits designated for general or specific processing tasks. The internal memory 1006 may be volatile or non-volatile memory, and may also be secure and/or encrypted memory, or unsecure and/or unencrypted memory, or any combination thereof. The touchscreen controller 1004 and the processor 1002 may also be coupled to a touchscreen panel 1012, such as a resistive-sensing touchscreen, capacitive-sensing touchscreen, infrared sensing touchscreen, etc. Additionally, the display of the multi-SIM mobile communication device 1000 need not have touch screen capability.

The multi-SIM mobile communication device 1000 may have one or more cellular network transceivers 1008 coupled to the processor 1002 and to one or more antennas 1010 and configured for sending and receiving cellular communications. The one or more transceivers 1008 and the one or more antennas 1010 may be used with the herein-mentioned circuitry to implement various embodiment methods. The multi-SIM mobile communication device 1000 may include one or more SIM cards 1016 coupled to the one or more transceivers 1008 and/or the processor 1002 and may be configured as described herein.

The multi-SIM mobile communication device 1000 may also include speakers 1014 for providing audio outputs. The multi-SIM mobile communication device 1000 may also include a housing 1020, constructed of a plastic, metal, or a combination of materials, for containing all or some of the components discussed herein. The multi-SIM mobile communication device 1000 may include a power source 1022 coupled to the processor 1002, such as a disposable or rechargeable battery. The rechargeable battery may also be coupled to the peripheral device connection port to receive a charging current from a source external to the multi-SIM mobile communication device 1000. The multi-SIM mobile communication device 1000 may also include a physical button 1024 for receiving user inputs. The multi-SIM mobile communication device 1000 may also include a power button 1026 for turning the multi-SIM mobile communication device 1000 on and off.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configurations. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc in which disks usually reproduce data magnetically, while discs reproduce data optically with lasers. Combinations of the storage media are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to some embodiments without departing from the spirit or scope of the written description. Thus, the present disclosure is not intended to be limited to the embodiments shown herein but is to be accorded the widest scope consistent with the following claims and the principles and novel features disclosed herein.

What is claimed is:

1. A method for calibrating receive chains on a mobile communication device, comprising:
identifying a calibrated receive chain of the mobile communication device;
identifying an un-calibrated receive chain of the mobile communication device;
obtaining a first series of gain measurements for the calibrated receive chain;
obtaining a second series of gain measurements for the un-calibrated receive chain;
determining a path gain difference between the calibrated receive chain and the un-calibrated receive chain based on the first series of gain measurements and the second series of gain measurements; and
compensating a gain of the un-calibrated receive chain based on the path gain difference.

2. The method of claim 1, further comprising:
determining whether a radio frequency (RF) resource of the mobile communication device is free for use during a first time period,
wherein obtaining the first series of gain measurements for the calibrated receive chain comprises:
tuning the RF resource to the calibrated receive chain; and
performing a plurality of measurement cycles during the first time period to obtain the first series of gain measurements, and
wherein obtaining the second series of gain measurements for the un-calibrated receive chain comprises:
tuning the RF resource to the un-calibrated receive chain; and
performing the plurality of measurement cycles during the first time period to obtain the second series of gain measurements.

3. The method of claim 2, further comprising:
adding a factory calibrated gain offset of the calibrated receive chain to an obtained gain measurement in the first series of gain measurements; and
adding the factory calibrated gain offset to an obtained gain measurement in the second series of gain measurements.

4. The method of claim 2, further comprising:
determining, at the beginning of each measurement cycle, whether a gain state of an amplifier in the calibrated receive chain has changed; and
ignoring previously obtained gain measurements for the calibrated receive chain and the un-calibrated receive chain in response to determining that the gain state of the amplifier in the calibrated receive chain has changed.

5. The method of claim 2, wherein each measurement cycle in the plurality of measurement cycles has a duration between 0.5 milliseconds and 2 milliseconds.

6. The method of claim 1, wherein determining the path gain difference between the calibrated receive chain and the un-calibrated receive chain comprises:
determining a series of raw gain differences between corresponding gain measurements in the first series of gain measurements and the second series of gain measurements; and
averaging the series of raw gain differences to obtain the path gain difference.

7. The method of claim 1, wherein compensating the gain of the un-calibrated receive chain based on the path gain difference comprises:
applying a factory calibrated gain offset of the calibrated receive chain and the path gain difference to the gain of the un-calibrated receive chain.

8. The method of claim 1, wherein the first series of gain measurements and the second series of gain measurements are obtained using at least one of the same radio access technology, same frequency, and same state of an amplifier.

9. The method of claim 8, further comprising extrapolating the path gain difference for different frequencies used by the un-calibrated receive chain.

10. The method of claim 1, wherein an input signal to the calibrated receive chain and the un-calibrated receive chain is obtained from a pilot signal broadcast from a network base station.

11. The method of claim 1, further comprising associating the path gain difference with the un-calibrated receive chain and storing the path gain difference in memory.

12. A mobile communication device, comprising:
a radio frequency (RF) resource; and
a processor coupled to the RF resource and configured with processor-executable instructions to:
identify a calibrated receive chain of the RF resource;
identify an un-calibrated receive chain of the RF resource;
obtain a first series of gain measurements for the calibrated receive chain;
obtain a second series of gain measurements for the un-calibrated receive chain;
determine a path gain difference between the calibrated receive chain and the un-calibrated receive chain based on the first series of gain measurements and the second series of gain measurements; and
compensate a gain of the un-calibrated receive chain based on the path gain difference.

13. The mobile communication device of claim 12, wherein the processor is further configured with processor-executable instructions to:
determine whether the RF resource of the mobile communication device is free for use during a first time period,
wherein the processor is further configured with processor-executable instructions to obtain the first series of gain measurements for the calibrated receive chain by:
tuning the RF resource to the calibrated receive chain; and
performing a plurality of measurement cycles during the first time period to obtain the first series of gain measurements, and
wherein the processor is further configured with processor-executable instructions to obtain the second series of gain measurements for the un-calibrated receive chain by:
tuning the RF resource to the un-calibrated receive chain; and
performing the plurality of measurement cycles during the first time period to obtain the second series of gain measurements.

14. The mobile communication device of claim 13, wherein the processor is further configured with processor-executable instructions to:
add a factory calibrated gain offset of the calibrated receive chain to an obtained gain measurement in the first series of gain measurements; and
add the factory calibrated gain offset to an obtained gain measurement in the second series of gain measurements.

15. The mobile communication device of claim 13, wherein the processor is further configured with processor-executable instructions to:
determine, at the beginning of each measurement cycle, whether a gain state of an amplifier in the calibrated receive chain has changed; and
ignore previously obtained gain measurements for the calibrated receive chain and the un-calibrated receive chain in response to determining that the gain state of the amplifier in the calibrated receive chain has changed.

16. The mobile communication device of claim 12, wherein the processor is further configured with processor-executable instructions to determine the path gain difference between the calibrated receive chain and the un-calibrated receive chain by:
determining a series of raw gain differences between corresponding gain measurements in the first series of gain measurements and the second series of gain measurements; and
averaging the series of raw gain differences to obtain the path gain difference.

17. The mobile communication device of claim 12, wherein the processor is further configured with processor-executable instructions to compensate the gain of the un-calibrated receive chain based on the path gain difference by:
applying a factory calibrated gain offset of the calibrated receive chain and the path gain difference to the gain of the un-calibrated receive chain.

18. The mobile communication device of claim 12, wherein the processor is further configured with processor-executable instructions to obtain the first series of gain measurements and the second series of gain measurements using at least one of the same radio access technology, same frequency, and same state of an amplifier.

19. The mobile communication device of claim 12, wherein the processor is further configured with processor-executable instructions to obtain an input signal to the calibrated receive chain and the un-calibrated receive chain from a pilot signal broadcast from a network base station.

20. The mobile communication device of claim 12, wherein the processor is further configured with processor-executable instructions to associate the path gain difference with the un-calibrated receive chain and store the path gain difference in memory.

21. A non-transitory computer readable storage medium having stored thereon processor-executable software instructions configured to cause a processor of a mobile communication device to perform operations comprising:
identifying a calibrated receive chain of the mobile communication device;
identifying an un-calibrated receive chain of the mobile communication device; obtaining a first series of gain measurements for the calibrated receive chain;
obtaining a second series of gain measurements for the un-calibrated receive chain;
determining a path gain difference between the calibrated receive chain and the un-calibrated receive chain based on the first series of gain measurements and the second series of gain measurements; and
compensating a gain of the un-calibrated receive chain based on the path gain difference.

22. The non-transitory computer readable storage medium of claim 21, wherein the stored processor-executable software instructions are configured to cause the processor of the mobile communication device to perform operations further comprising:
determining whether a radio frequency (RF) resource of the mobile communication device is free for use during a first time period,
wherein the stored processor-executable software instructions are configured to cause the processor of the mobile communication device to perform operations such that obtaining the first series of gain measurements for the calibrated receive chain comprises:
tuning the RF resource to the calibrated receive chain; and
performing a plurality of measurement cycles during the first time period to obtain the first series of gain measurements, and
wherein the stored processor-executable software instructions are configured to cause the processor of the mobile communication device to perform operations such that obtaining the second series of gain measurements for the un-calibrated receive chain comprises:
tuning the RF resource to the un-calibrated receive chain; and
performing the plurality of measurement cycles during the first time period to obtain the second series of gain measurements.

23. The non-transitory computer readable storage medium of claim 22, wherein the stored processor-executable software instructions are configured to cause the processor of the mobile communication device to perform operations further comprising:
adding a factory calibrated gain offset of the calibrated receive chain to an obtained gain measurement in the first series of gain measurements; and
adding the factory calibrated gain offset to an obtained gain measurement in the second series of gain measurements.

24. The non-transitory computer readable storage medium of claim 22, wherein the stored processor-executable software instructions are configured to cause the processor of the mobile communication device to perform operations further comprising:
determining, at the beginning of each measurement cycle, whether a gain state of an amplifier in the calibrated receive chain has changed; and
ignoring previously obtained gain measurements for the calibrated receive chain and the un-calibrated receive chain in response to determining that the gain state of the amplifier in the calibrated receive chain has changed.

25. The non-transitory computer readable storage medium of claim 21, wherein the stored processor-executable software instructions are configured to cause the processor of the mobile communication device to perform operations such that determining the path gain difference between the calibrated receive chain and the un-calibrated receive chain comprises:
determining a series of raw gain differences between corresponding gain measurements in the first series of gain measurements and the second series of gain measurements; and
averaging the series of raw gain differences to obtain the path gain difference.

26. The non-transitory computer readable storage medium of claim 21, wherein the stored processor-executable software instructions are configured to cause the processor of the mobile communication device to perform operations such that compensating the gain of the un-calibrated receive chain based on the path gain difference comprises:
applying a factory calibrated gain offset of the calibrated receive chain and the path gain difference to the gain of the un-calibrated receive chain.

27. The non-transitory computer readable storage medium of claim 21, wherein the first series of gain measurements and the second series of gain measurements are obtained using at least one of the same radio access technology, same frequency, and same state of an amplifier.

28. The non-transitory computer readable storage medium of claim 21, wherein an input signal to the calibrated receive chain and the un-calibrated receive chain is obtained from a pilot signal broadcast from a network base station.

29. The non-transitory computer readable storage medium of claim 21, wherein the stored processor-executable software instructions are configured to cause the processor of the mobile communication device to perform operations further comprising:
associating the path gain difference with the un-calibrated receive chain and storing the path gain difference in memory.

30. A mobile communication device, comprising:
means for identifying a calibrated receive chain of the mobile communication device;
means for identifying an un-calibrated receive chain of the mobile communication device;
means for obtaining a first series of gain measurements for the calibrated receive chain;
means for obtaining a second series of gain measurements for the un-calibrated receive chain;
means for determining a path gain difference between the calibrated receive chain and the un-calibrated receive chain based on the first series of gain measurements and the second series of gain measurements; and
means for compensating a gain of the un-calibrated receive chain based on the path gain difference.
